(19) United States
(12) Patent Application Publication
(10) Pub. No.: US 2010/0186660 A1
(43) Pub. Date: Jul. 29, 2010

(54) Multiple bookmarker

(76) Inventor: Denise Annette Vinson Taylor, Columbia, SC (US)

Correspondence Address: Denise Annette Vinson Taylor, 29 Barrister Drive, Columbia, SC, 29223, US

(21) Appl. No.: 12/321,975

(22) Filed: Jan. 28, 2009

(51) Int. Cl. B42D 9/00

(52) U.S. Cl. 116/234

(57) ABSTRACT

This present invention is a bookmarker like no other bookmarker. Because it will hold up to eight pages in one book at one time and becomes a part of the book with out falling out. Eight different markers that can be moved from page to page at will.

### CROSS-REFERENCE TO RELATED APPLICATION

“Not Applicable”

### BACKGROUND OF INVENTION

This present invention relates to a bookmarker. Although bookmarkers have in the past hold a single page in a book at one.

This bookmarker will hold up to eight pages at one time in one book and becomes a part of the book until you take it out of the book.

### BRIEF SUMMARY OF THE INVENTION

This invention is not like other bookmarker. It becomes a part of the book and holds up to eight pages at one time. It will not fall out you have to remove it. Unlike other bookmarkers that fall out and hold only one page at one time.

### BRIEF DESCRIPTION OF SEVERAL VIEWS OF THE DRAWING

FIG. 1A is a depiction of the eight ribbons at 11¾ inches in length and ¼ inches in width.

FIG. 2A is a depiction of the elastic which forms a circle at 5¾ inches and sewn to the eight ribbons. The elastic is then stretched open and half of the book is placed though it.

FIG. A3 is showing the threads that are sewn three times. That is holding the ribbons and elastic together.

FIG. A4 is showing the eight ribbons at the ends that are lightly singed to keep the ends from coming a part.

FIG. 5 though 7 is Not Applicable

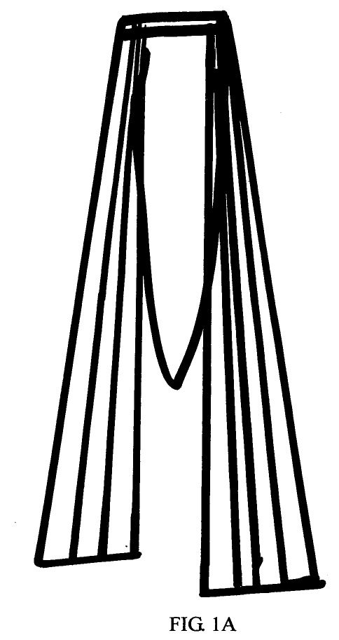

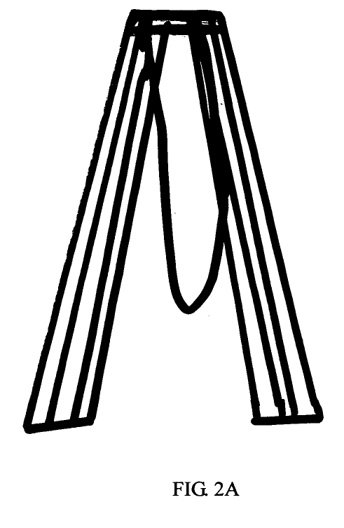

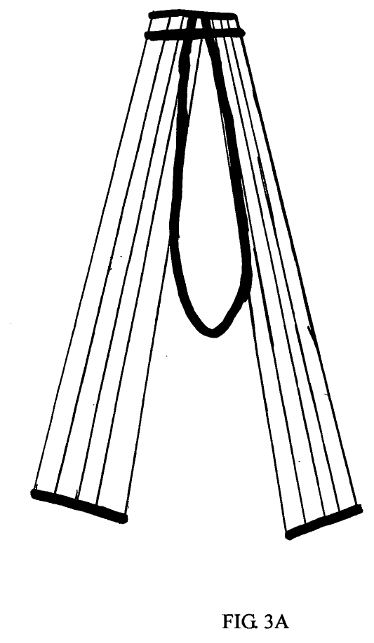

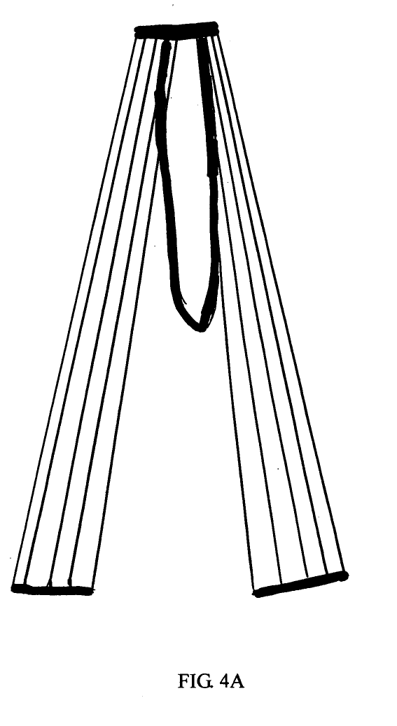

This is a process of making and using this invention.

Take four pieces of ribbon 24 inches in length and ¼ inch in width and one piece of elastic 11½ inches in length and ⅛ of an inch in width. Lay all four pieces of ribbon on top of each other. Place the open ends of the elastic at the center of the ribbon.

This makes the ribbon 12 inches long and the elastic 5¾ inches long holding all pieces together on top of each other with the elastic in the center at the 12 inch mark.

The ribbons and the elastic are then sewn together three times at the ¼ inch down from the fold. The elastic is in the center of the four pieces of ribbon. After sewing this makes them 8 ribbons 10¾ inches in length and the elastic becomes a 5¼ inches circle. All eight ribbons are lightly singed at the open ends. It will give you 8 multiple bookmarkers. Take half of a book put it thru the center of the elastic and use the ribbon to mark your pages one by one. The bookmarker becomes a part of the book and will not fall out of the book.

### DETAILED DESCRIPTION OF THE INVENTION

This is the detail description and constructed as will as use of this invention.

Take four pieces of ribbon 24 inches in length and ¼ inch in width and one piece of elastic 11½ inches in length and ⅛ of an inch in width. Lay all four pieces of ribbon on top of each other. Place the open ends of the elastic at the center of the ribbon.

This makes the ribbon 12 inches long and the elastic 5¾ inches long holding all pieces together on top of each other with the elastic in the center at the 12 inch mark.

The ribbons and the elastic are then sewn together three times at the ¼ inch down from the fold. The elastic is in the center of the four pieces of ribbon. After sewing this makes them 8 ribbons 10¾ inches in length and the elastic becomes a 5¼ inches circle. All eight ribbons are lightly singed at the open ends. It will give you 8 multiple bookmarkers. Take half of a book put it thru the center of the elastic and use the ribbon to mark your pages one by one. The bookmarker becomes a part of the book and will not fall out of the book.

1. What I claim as an invention is that this is the only multiple bookmarker that will hold up to eight pages in one book at one time without falling out of the book because it becomes a part of the book until you take it out.
